(19) United States
(12) Patent Application Publication
(10) Pub. No.: US 2012/0030699 A1
(43) Pub. Date: Feb. 2, 2012

(54) SYSTEMS AND METHODS FOR STORING AND RENDERING ATLEAST AN USER PREFERENCE BASED MEDIA CONTENT

(76) Inventor: Umesh AMIN, Redmond, WA (US)

(21) Appl. No.: 13/194,968

(22) Filed: Jul. 31, 2011

Related U.S. Application Data
(60) Provisional application No. 61/369,724, filed on Aug. 1, 2010.

(51) Int. Cl. H04N 21/266

(52) U.S. Cl. 725/28

(57) ABSTRACT

Disclosed are systems and methods for storing and rendering atleast a desired media content of a mixed rated media according to user preference. The method comprises the steps of: inputting atleast a preference of the desired media content of the mixed rated media to atleast a media player; editing out undesired media content of the mixed rated media; and rendering the desired media contents according to the user preference.

### CROSS-REFERENCE TO RELATED APPLICATION

This non-provisional patent application claims priority from the U.S. provisional patent application Ser. No. 61/369,724 filed on Aug. 1, 2010, the content of which is incorporated herein by reference.

### FIELD OF THE INVENTION

The present invention relates generally to rendering media contents, and more particularly, to systems and methods for rendering user preference based media content of a mixed rated media in a secure, efficient, cost effective, and family friendly viewing manner.

### BACKGROUND OF THE INVENTION

There are many parental control mechanisms developed and practiced to educate consumers and media providers to safeguard from situations where an inappropriate media is presented to minors. Most of movies, TV Programs, web content, videos, music, and games have self regulated rating systems that educate viewers or consumers of the types of media and implicit requirements of suitability of viewers or consumers in different age demographics.

Media rendering systems like set-top boxes, TV systems, and gaming systems have provision for configuring the systems for parental control and guidance. Media storage systems like DVDs, CDs, and game programs have rating system that directs users to observe the rating. In most cases, a very small subset of the entire program is responsible for the overall higher restrictive rating for the entire program.

The prior art discloses different techniques for parental control of media content, for example, US patent publication No. 201000953 discloses a digital broadcast recording/reproducing apparatus and parental control method for digital television program. The apparatus includes a control portion performing parental control of a digital television program on the basis of rating information. The control portion is formed to recognize whether or not the rating information is updated from that at the time of recording of the digital television program when reproducing the recorded digital television program and to inquire of the user as to whether or not to perform parental control of the digital television program if the rating information is updated at the time of reproduction.

US Patent publication No. 20100050216 discloses an on-demand content control apparatus which is based on parental control setting. The apparatus includes a request receiver, a content selector, and a transmission initiator. The request receiver receives a request from a remote player for a transmission of on-demand content. The request includes a rating control setting. The rating control setting indicates an allowable rating for the on-demand content. The content selector identifies a content file relating to the on-demand content with a rating matching the rating control setting. The content selector also selects, based on the rating control setting, the identified content file for the transmission to the remote player. The transmission initiator initiates the transmission of the selected content file to the remote player.

US Patent publication No. 20090320057 discloses a parental control method, including receiving a channel selection command from a user to select from a plurality of channels for playing, each of the channels having a plurality of programming content, performing a parental control procedure prior to allowing playing of the programming content of one of the channels, during atleast one specific timeslot, and allowing playing of the programming content prior to performing a parental control procedure for atleast one of the following the one channel outside of the atleast one specific timeslot, and another one of the channels.

US Patent publication No. 20090204986 discloses a method for performing parental control a channel for building a channel map in an internet protocol television (IPTV) receiver and the IPTV receiver. The method includes receiving a master service information (SI) table including a first element defining location of a virtual channel map table, parsing the first element in the received master SI table, receiving the virtual channel map table including a second element defining location of a virtual channel description table based on the parsed location element, parsing the second element in the received virtual channel map table, receiving the virtual channel description table, which includes a third element indicating a default parental guidance rating of a virtual channel service when present, based on the parsed second element, parsing the third element in the received virtual channel description table, and controlling to allow ratings based on the type of parental guidance system according to the parsed third element.

US Patent publication No. 20090172552 discloses a method and apparatus for controlling presentation of content at a user terminal. The invention controls presentation of content at an end user terminal to allow an end user to consume any kind of content without specifying anything about how the content is delivered. A method includes creating a content schedule, determining content presentation control information using the content schedule, and using the content presentation control information to control the presentation of content on one or more end user terminals. The content schedule, which identifies a plurality of content items intended for the end user terminal, includes atleast one content characteristic associated with each of the content items. The content presentation control information is adapted for controlling presentation of the content items at the end user terminal in a manner tending to render the content characteristics transparent to the end user. The content items may be distributed using different content distribution modes, which include atleast one time-dependent distribution mode and atleast one time-independent distribution mode. The content presentation control information controls the presentation of content at the end user terminal.

US Patent publication No. 20090089827 discloses a method for specific screen-area targeting for parental control video blocking. The method comprising receiving input regarding a type of potentially objectionable video content (POC) that is to be filtered when displaying video content, receiving a video signal containing an indication of a display location of POC in the video content and a type of POC at that display location, and filtering display of content identified by the indication of the display location of the POC and the type of the POC if the type of POC corresponds to the type of POC that is to be filtered when displaying the video content.

US Patent publication No. 20030172377 discloses a method and apparatus for selectively accessing programs in a parental control system. A rating limit is set corresponding to first user input and an exception to the rating limit is set corresponding to a second user input. Information for specifying the rating of a program and for identifying the program is received. The rating is compared with the stored rating limit and it is determined using the information for identifying the program whether an exception from the rating limit for the program has been set. Access to the program is controlled in response to the results of the comparing and checking of the received information.

US Patent publication No. 20030115592 discloses a method and apparatus for selecting rating limits in a parental control system. Rating limits, which define whether programs are to be blocked or are deemed to be acceptable, are selected in a program content filtering system. For that purpose information about a rating example is reproduced and atleast one recommended rating assigned to the rating example is supplied. An user indication about the acceptability of said rating example is detected and assigned to the recommended rating. A rating limit is derived in response to the user indication. The above steps may be repeated if needed to provide sufficient data to enable deriving one or more rating limits from the user indications assigned to the ratings.

U.S. Pat. No. 6,321,381 discloses an apparatus and method for parental control of television programs. Program schedule information including program titles are stored in a memory and displayed on a monitor. Compressed code is entered for the programs to be blocked. Alternatively, one or more program titles are selected from the displayed program schedule information for blocking by a parental control circuitry connected to a controller.

While all these systems and processes do an adequate job in providing parental control of viewing content, however, they fail in providing a family friendly viewing environment for a mixed rating content.

Accordingly, there is no means exists in the present time which is capable of providing a family friendly viewing environment for a mixed rating content by automatically editing out inappropriate content in a real-time based on the user preference and presenting rest of the content in a contiguous fashion for viewer consumption.

In view of the disadvantages inherent in the conventional means of controlling viewing content, it has remained a constant concern to provide for more practical, more efficient cost effective means for a family friendly viewing environment for a mixed rating content.

### SUMMARY FOR THE INVENTION

In view of the disadvantages inherent in the conventional means of content controlling and rendering, the general purpose of the present invention is to provide effective systems and methods by which inappropriate media content of a mixed rated media may be automatically edited out in a real-time based on the user preference and rest of the content may be rendered in a contiguous fashion for viewer consumption, in more practical, more efficient, cost effective, and family friendly viewing environment, to include advantages of the existing systems and methods, and to overcome the drawbacks inherent therein.

In one aspect, if a consumer wishes to consume a mixed rating media, the present invention is capable of permitting a user to submit viewer rating preference and the content is rendered accordingly. For example, parents wish to view a PG 13 movie with their family that includes kids below the age of 13 without the content that make the movie PG 13, the parents may input to the movie player their preference of PG. The movie player may automatically edit out any content that makes the movie PG 13 and play out or render the movie as if it was PG.

In another aspect of the invention, atleast a media storage system may have frame by frame sequencing reference with different rating system such that each frame may be included or excluded in sequencing for rendering of the media by the rating preference of the consumer or viewer.

In yet another aspect, the present invention provides a method for storing and rendering atleast a desired media content of a mixed rated media according to user preference. The method comprises the steps of: inputting atleast an user preference of the desired media content of the mixed rated media to atleast a media player, editing out undesired media content of the mixed rated media, and rendering the desired media contents according to the received user preference.

In another aspect, of the present invention provides a method for rendering of a mixed content scenario based on rating preference. The method comprises the steps of: viewing mixed rated media, checking atleast a rating of a media content, checking atleast a change preference to allow broader audience if the rating of the media content is higher than the received user preference; and rendering the media content if the media content rated is aligned with the user preference.

In another aspect, the present invention provides a system for storing and rendering atleast a desired media content of a mixed rated media according to an user preference. The system comprises: means for inputting atleast a preference of the desired media content of the mixed rated media; means for editing out undesired media content of the mixed rated media; and means for rendering the desired media contents according to the user preference.

In another aspect, the present invention is capable of providing feedback to the user about what different explicit preferences are available for user to screen in or out of the media consumption. In this aspect of the invention, user may be given a series of choices about what they would like to view and not view. Based on these user preferences, for example, adult language is acceptable but sexually explicit situation is not acceptable, the content presentation is altered or selected in real-time and rendered to the user.

In yet another aspect, the present invention provides a system from which a user may request the rationale for a given rating of the mixed rated media and the system may displays the categories, for example, mature language, violence, adult situation, nudity, etc. The system may also provide the means for the user to view those content category media to decide if that is acceptable for their content rendering. Based on this capability, for a mixed rated content (e.g. PG 13 because of mature language and adult situation), parents may watch those portions with displayed categories and may determine that the mature language is acceptable to them while adult situation is not. In that case, they may provide the system with more informed preference on how mixed content may be rendered.

These together with other aspects of the present invention, along with the various features of novelty that characterize the invention, are pointed out with particularity in the detailed description forming a part of this disclosure. For a better understanding of the present invention, its operating advantages, and the specific objects attained by its uses, reference should be made to the accompanying drawings and descriptive matter in which, there are illustrated exemplary embodiments of the present invention.

### BRIEF DESCRIPTION OF THE DRAWINGS

The advantages and features of the present invention will become better understood with reference to the following more detailed description taken in conjunction with the accompanying drawings, in which like elements are identified with like symbols, and in which:

FIG. A illustrates an exemplary scale of various ratings for movies sets by the movie rating association;

FIG. B illustrates an exemplary comparison table of currently active game rating systems;

FIG. 1 illustrates a method for storing and rendering atleast a desired media content of a mixed rated media according to user preference, according to an exemplary embodiment of the present invention;

FIG. 2 illustrates a method for storing and rendering atleast a desired media content of a mixed rated media according to user preference, according to an exemplary embodiment of the present invention;

FIG. 3 illustrates a method for rendering of a mixed content scenario based on rating preference, according to an exemplary embodiment of the present invention;

FIG. 4 illustrates a method for rendering of a mixed content scenario based on rating preference, according to an exemplary embodiment of the present invention;

FIG. 5 illustrates a method for rendering of a mixed content scenario based on rating preference, according to an exemplary embodiment of the present invention; and

FIG. 6 illustrates a system for rendering of a mixed content scenario based on rating preference, according to an exemplary embodiment of the present invention.

Like reference numerals refer to like parts throughout several views of the drawings of the present invention.

### DETAILED DESCRIPTION OF THE INVENTION

The exemplary embodiments described herein detail for illustrative purposes are subject to many variations and structure and design. It should be emphasized, however that the present invention is not limited to a particular system and methods for storing and rendering user preference based media content of a mixed rated media as shown and described. Rather, the principles of the present invention may be used with a variety of storing and rendering user preference based media content of a mixed rated media configurations and structural arrangements. It is understood that various omissions, substitutions of equivalents are contemplated as circumstances may suggest or render expedient, but the present invention is intended to cover the application or implementation without departing from the spirit or scope of the its claims.

In the following description, for purposes of explanation, numerous specific details are set forth in order to provide a thorough understanding of the present invention. It will be apparent, however, to one skilled in the art that the present invention may be practiced without these specific details.

As used herein, the term ‘plurality’ refers to the presence of more than one of the referenced item and the terms ‘a’, ‘an’, and ‘atleast’ do not denote a limitation of quantity, but rather denote the presence of atleast one of the referenced item. The term ‘rendering’ may also be referred to as ‘playing’ or ‘displaying’ or ‘presenting’ or ‘running’. The term ‘user’ may also be referred to as ‘viewer’ or ‘customer’ or ‘family’. The term ‘inputting’ may also be referred to as ‘receiving’.

According to an exemplary embodiment, the present invention provides effective systems and methods for storing and rendering user preference based content of a mixed rated media such that inappropriate content may be automatically edited out in a real-time based on the user preference and rest of the content may be presented in a contiguous fashion for viewer consumption, in a secure, efficient, cost effective, and family friendly viewing manner.

In a family viewing situation with a mixed viewer audience of adults and children under the age of 13, there is a need for the family to be able to view a movie or play games together taking into consideration some media may not be appropriate for younger members of the family. The media may includes movie, video, pictures, audio, moving pictures, still pictures, music, music videos, games, audible stories, written stories, image, text, and news

Referring to FIGS. A and B, wherein FIG. A illustrates a scale of various ratings for movies. FIG. B illustrates a comparison table of currently active game rating systems wherein age is shown on the horizontal axis. The movie rating association sets the various ratings for movies. Generally, lower rating having broader audience and higher rating having narrower audience. Broader audience translates to a lower rating as described in the rating scale (FIG. A). This may be preferable in a family environment with a mixed-aged audience. If the original selected media is rated PG-13 or higher, then a media system according to the present invention may provide the family an option to select a different rating to view an appropriate media. In this scenario, the rating of PG is selected. Since the most appropriate rating for the family to watch a selected movie together is the PG rating, the media player takes the PG rating selection entered by the family and edits the contents of media to present a PG-rated media content.

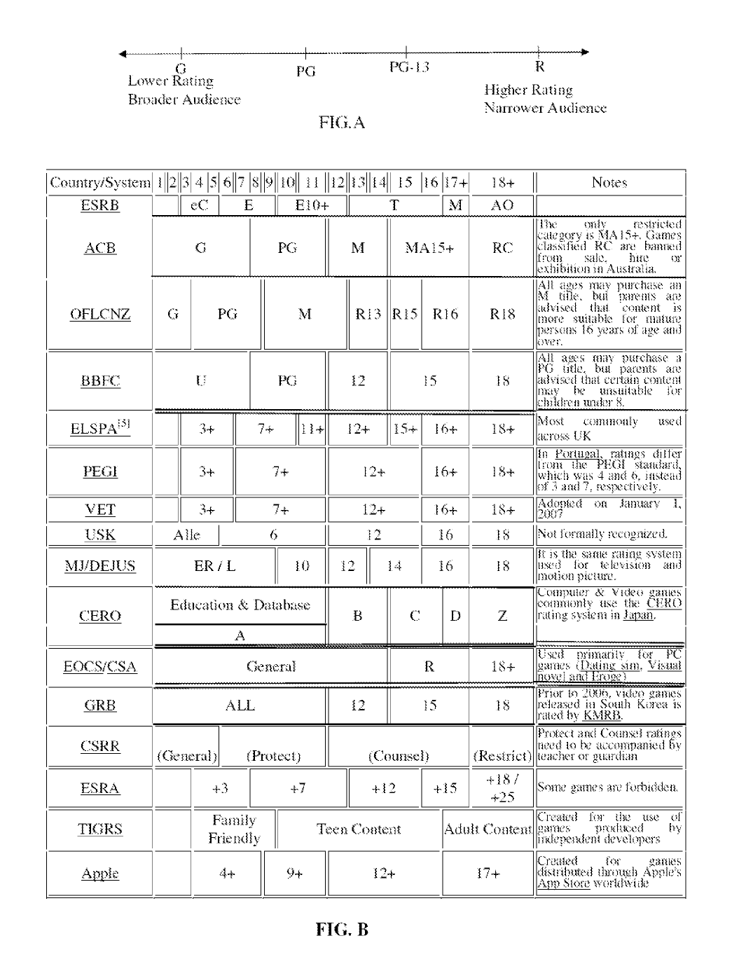

Referring to FIG. 1 which illustrates a method 100 for storing and rendering atleast a desired media content of a mixed rated media according to user preference, according to an exemplary embodiment of the present invention. The method 100 comprises the steps of: inputting atleast a preference of the desired media content of the mixed rated media to atleast a media player at a step 110; editing out undesired media content of the mixed rated media at a step 120; and rendering the desired media contents according to the user preference at a step 130. The method 100 further comprises the steps of permitting a user to submit viewer rating preference for presenting the media content and compiling and running the media content of a mixed rated media according to user preference.

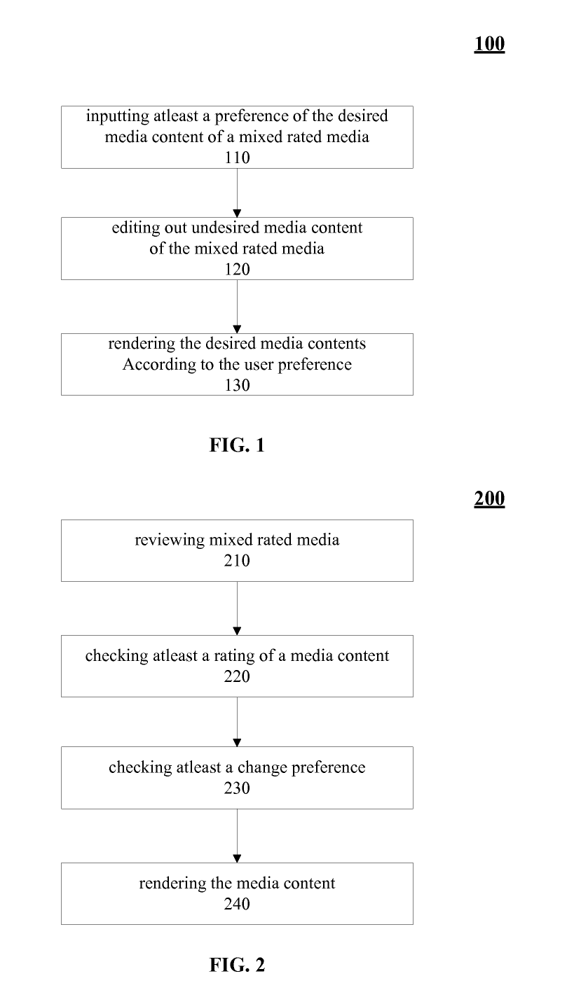

Referring to FIG. 2 which illustrates a method 200 for storing and rendering atleast a desired media content of a mixed rated media according to user preference, according to an exemplary embodiment of the present invention. The method 200 comprises the steps of: viewing mixed rated media at a step 210; checking whether atleast a rating of a media is PG-13 or higher at a step 220; checking atleast a change preference to allow broader audience if the rating of the media content is PG-13 or higher at a step 230; and rendering the media content if the media content rated is neither PG-13 nor higher at a step 240.

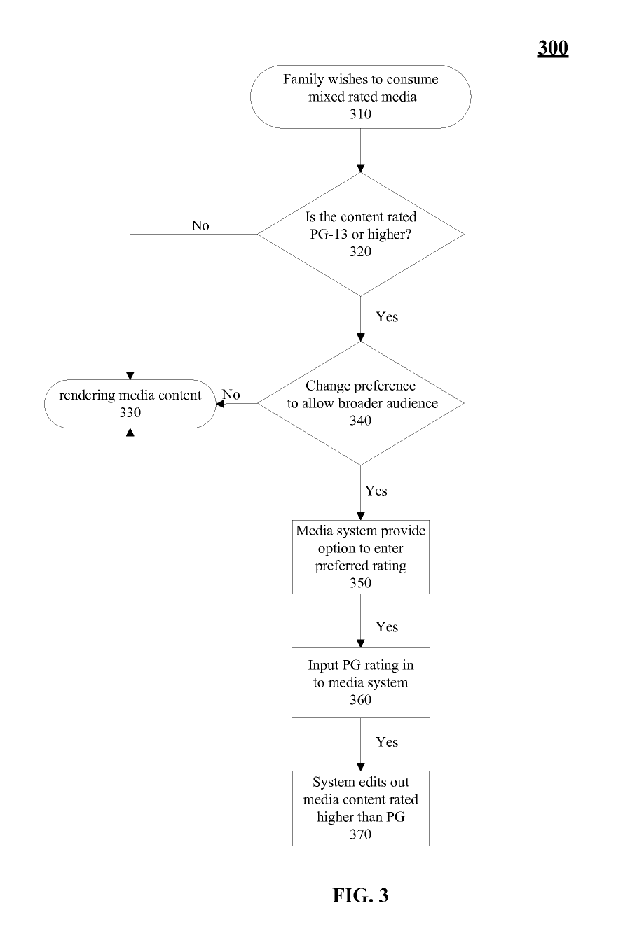

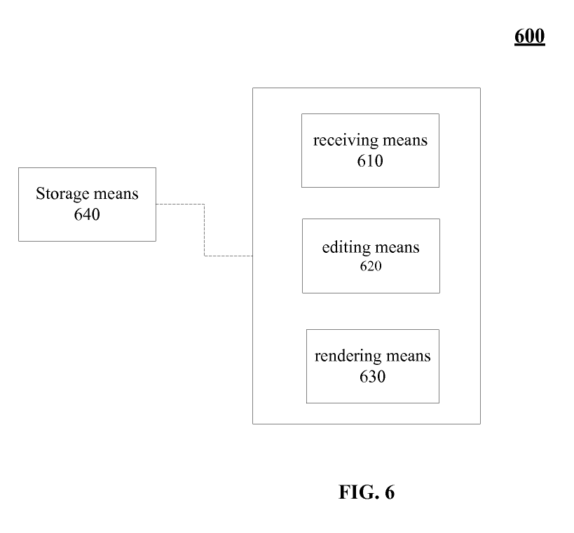

Referring to FIG. 3 which illustrates a method 300 for rendering of a mixed content scenario based on rating preference, according to an exemplary embodiment of the present invention. The consumer such as a family, wishes to consume mixed rated media at a step 310. The mixed rated media includes a single media input that may be rendered in a rating level. The rating label includes atleast any one of PG, R, PG-13 or any combination such as PG and PG-13, or PG-13 and R. A system 600 (as shown in FIG. 6) which is capable of processing steps of the method 300 of the present invention, may performs a check weather the content rated is PG-13 or higher, at a step 320. If the content rated is neither PG-13 nor higher, then the media content may be displayed and user/family may watch movie at a step 330.

If the content rated has the rating PG-13 or higher, then the system may check for change preferences to allow broader audience at a step 340. If a response to the checking for change preferences to allow broader audience at the step 340 is ‘No’, then the user/family may watch movie at the step 330. If the response to the checking for change preferences to allow broader audience at the step 340 is ‘Yes’, then a media system, which is adapted to implement steps of the method according to the present invention, may provide option to enter preferred rating at a step 350.

Based on the media input, the media system may present rating based multiple selections and/or ratings for viewing the content. The consumer/user may select and input the PG rating into the media system at a step 360, then contents related to the PG rating, which is the preferred rating in this scenario, may be presented on a viewing screen.

Each scene in the media comes tagged with a rating. The media system edits out all scenes or media content that have a rating higher than PG at a step 370 and renders a PG rated movie at the step 130.

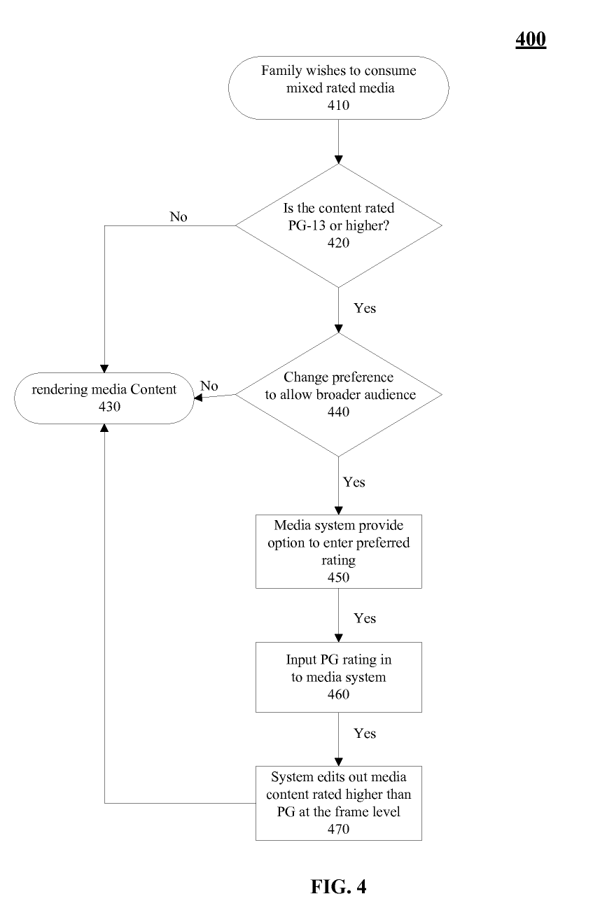

Referring to FIG. 4 which illustrates another method 400 for rendering of a mixed content scenario based on rating preference, according to an exemplary embodiment of the present invention. The consumer e.g. a family wishes to consume mixed rated media at a step 410. The system may performs a check weather the content rated is PG-13 or higher, at a step 420. If the content rated is neither PG-13 nor higher, then the media content may be displayed and user/family may watch movie at a step 430.

If the content rated has the rating PG-13 or higher, then the system may check for change preferences to allow broader audience at a step 440. If a response to the checking for change preferences to allow broader audience at the step 440 is ‘No’, then the user/family may watch movie at the step 430. If the response to the checking for change preferences to allow broader audience at the step 440 is ‘Yes’, then a media system, which is adapted to implement steps of the method according to the present invention, may provides option to enter preferred rating at a step 450.

Based on the media input, the media system may present rating based multiple selections and/or ratings for viewing the content. The consumer/user may select and input the PG rating into the media system at a step 460, then contents related to the PG rating, which is the preferred rating in this scenario, may be presented on a viewing screen.

Each frame in the media comes tagged with a rating. At a step 470, the system edits out media content rated higher than PG at the frame level, i.e., the media system edits in all frames with a PG rating and edits out all frames with a rating higher than PG at a step 270. A PG-rated movie is rendered by the media system at a step 230.

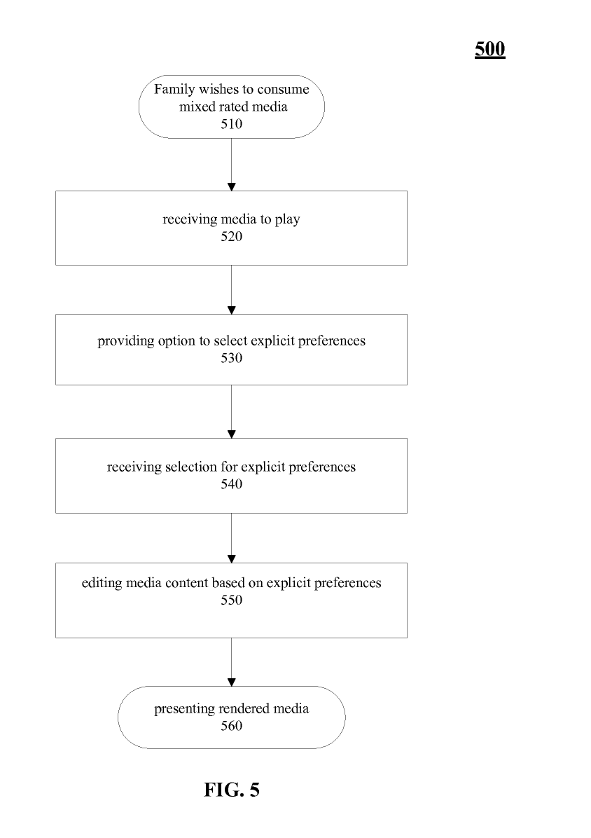

Referring to FIG. 5 which illustrates a method 500 for rendering of a mixed content scenario based on rating preference, according to an exemplary embodiment of the present invention. At a step 510, the consumer/family wishes to consume mixed-rated media. Mixed rated media means that a single media input may be rendered in more than one rating level, such as PG and PG-13, or PG-13 and R. At a step 520, media system receives media to play, wherein viewer may provides media to media player. At a step 530, the media system may provide option to select explicit preference. After the media has been inserted into the media system, the media system may provide several options for explicit viewing preferences such as, no sexually explicit material, no adult language, no violence, etc. Multiple selections may be allowed.

At a step 540, the media system may receive selection for explicit preferences. The media system receives a single or multiple selections for explicit viewing preferences. For example, sexually explicit material is not allowed but adult language is allowed. At a step 550, the system may edit media content based on explicit preferences. Based on the explicit preferences, the media system may perform an edit of the media in order to produce a media that may be complete for viewing and may be customized for the viewer. At a step 560, a rendered media may be presented, i.e., complete edited media with viewer's preferences may be presented for viewing by the media system.

Referring to FIG. 6 which illustrates a system 600 for storing and rendering atleast a desired media content of a mixed rated media according to user preference, according to an exemplary embodiment of the present invention. The system 600 comprises: input means 610, editing means 620, rendering means 630, and storage means 640. The input means 610 are adapted for inputting atleast a preference of the desired media content of the mixed rated media to atleast a media player. The editing means 620 are adapted for editing out undesired media content of the mixed rated media. The rendering means 630 are adapted for playing the desired media contents according to the user preference. The storage means 640 may have frame by frame sequencing reference with different rating system so each frame may be included or excluded in sequencing for rendering of the media by the rating preference of the consumer.

According to an exemplary embodiment, the present invention provides effective systems and methods by which inappropriate content may be automatically edited out in a real-time based on the user preference and rest of the content may be presented in a contiguous fashion for viewer consumption in more efficient, cost effective, and family friendly viewing manner.

According to an exemplary embodiment of the present invention, if a consumer wishes to consume a mixed rating media, the present invention is capable of permitting a user to submit viewer rating preference and the content is presented accordingly. For example, parents wish to view a PG 13 movie with their family that includes kids below the age of 13 without the content that make the movie PG 13, they may input to the movie player their preference of PG. The media player may automatically edit out any content that makes the movie PG 13 and play out the movie as if it was PG.

In this example, the media player includes atleast any one of a movie player, a DVD player with or without display, a set-top box capable of rendering content on demand or pay-per-view or through DVR, a DVR player, an on-line internet media streaming apparatus, a personal computer, a game rendering system, radio, cell phone, voicemail, television, MPEG player, web browser, or virtually any other type of media player that supports video content rendering or any combination thereof.

The game rendering system may include atleast one of a game console like Nintendo or X-Box, a personal computer, an on-line internet gaming apparatus, any other media player that supports video game rendering system or any combination thereof.

In another example, parents wish to play a mixed rated electronic video game with kids below the age 13 without the content that makes the game rating T or higher, the parents may input to the game rendering system their preference for E10+ and the game rendering system may render the game in such a way that the player preference may be matched to E10+. In this example, the game rending system may includes atleast any one of a game console like Nintendo or X-Box, a personal computer, an on-line internet gaming apparatus, any other media player that supports video game rendering system or any combination thereof.

According to an exemplary embodiment of the present invention, a media storage system may have frame by frame sequencing reference with different rating system so each frame may be included or excluded in sequencing for rendering of the media by the rating preference of the consumer.

According to an exemplary embodiment of the present invention, the present invention is capable of providing means for taking the consumer input for media rating and/or preference consumption.

According to an exemplary embodiment, the present invention is capable of providing feedback to the user about what different explicit preferences are available for user to screen in or out of the media consumption. In this aspect of the invention, user may be given a series of choices about what they would like to view and not view. Based on these user preferences, for example, adult language is acceptable but sexually explicit situation is not acceptable, the content presentation is altered or selected in real-time and presented to the consumer.

According to an exemplary embodiment, the present invention provides a system from which a user may request the rationale for a given rating of the mixed rated media and the system displays the categories, for example, mature language, violence, adult situation, nudity, etc. The system may also provide the means for the user to view those content category media to decide if that is acceptable for their content rendering. Based on this capability, for a mixed rated content (e.g. PG 13 because of mature language and adult situation), parents may watch those portions with displayed categories and may determine that the mature language is acceptable to them while adult situation is not. In that case, they may provide the system with more informed preference on how mixed content may be displayed.

In various exemplary embodiments of the present invention, the operations discussed herein, e.g., with reference to FIGS. A-B and 1-6, may be implemented through computing devices such as hardware, software, firmware, or combinations thereof, which may be provided as a computer program product, e.g., including a machine-readable or computer-readable medium having stored thereon instructions or software procedures used to program a computer to perform a process discussed herein. The machine-readable medium may include a storage device. For example, the operation of components of the system 600 of FIG. 6 or implementation of steps of methods 100, 200, 300, 400, and 500 of FIGS. 1-5 may be controlled by such machine-readable medium.

In other instances, well-known methods, procedures, components, and circuits have not been described herein so as not to obscure the particular embodiments of the present invention. Further, various aspects of embodiments of the present invention may be performed using various means, such as integrated semiconductor circuits, computer-readable instructions organized into one or more programs, or some combination of hardware and software.

Although a particular exemplary embodiment of the invention has been disclosed in detail for illustrative purposes, it will be recognized to those skilled in the art that variations or modifications of the disclosed invention, including the rearrangement in the configurations of the parts, changes in sizes and dimensions, variances in terms of shape may be possible. Accordingly, the invention is intended to embrace all such alternatives, modifications and variations as may fall within the spirit and scope of the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. A method for storing and rendering atleast a desired media content of a mixed rated media according to an user preference, comprising the steps of:
receiving atleast the user preference of the desired media content of the mixed rated media;
editing out undesired media content of the mixed rated media; and
rendering the desired media contents according to the user preference.

2. The method of claim 1, further comprising atleast any one of the steps of permitting the user to submit viewer rating preference for rendering the media content according to the user preference and compiling and running atleast an altered media content of the mixed rated media according to the user preference in real time.

3. The method of claim 1, further comprising the steps providing atleast one of feedback and choices to the user about a plurality of different explicit preferences to screen in or out of the media rendering.

4. The method of claim 1, wherein if an original selected media is rated PG-13 or higher then a media system provides the user an option to select a different rating to view an appropriate media.

5. A method for rendering of a mixed content scenario based on atleast a received user rating preference, comprising the steps of:
reviewing mixed rated media;
checking atleast a rating of a media content;
checking atleast a change preference to allow broader audience if the rating of the media content is higher than the received user preference; and
rendering the media content if the media content rated is aligned with the user preference.

6. The method of claim 5, wherein the media system is capable of presenting rating based multiple selections and ratings for viewing the desired media content.

7. The method of claim 5, wherein atleast one of each content and scene in the mixed rated media is tagged with a rating.

8. The method of claim 5, wherein the media system is capable of editing out all scenes or media content that has a rating higher than a PG rating and renders a PG rated media content.

9. The method of claim 5, wherein atleast an inappropriate content of the mixed rated media is automatically edited out in a real-time based on the user preference and rests of the contents are presented in a contiguous fashion for viewer consumption.

10. The method of claim 5, wherein atleast a game rendering system is adapted for receiving user preference input for a desired media and rendering the desired media content in order of user preference, wherein the user preference includes E10+.

11. A system for storing and rendering atleast a desired media content of a mixed rated media according to user preference, comprising:
means for receiving atleast a preference of the desired media content;
means for editing out undesired media content of the mixed rated media; and
means for rendering the desired media contents according to the user preference.

12. The system of claim 11, wherein means are adapted for storing and rendering user preference based content, wherein said means for storing and rendering are capable of automatically editing out inappropriate content in a real-time and presenting rest of the content in a contiguous fashion for viewer consumption in a family friendly viewing environment.

13. The system of claim 11, wherein the mixed rated media includes a single media input which is capable of being rendered in a rating level.

14. The system of claim 11, wherein the media includes atleast one of a movie, a video, a picture, an audio, moving pictures, still pictures, music, music videos, games, audible stories, written stories, image, text, news or any combination thereof.

15. The system of claim 11, wherein a media storage system have frame by frame sequencing reference with different rating system such that each frame is included or excluded in sequencing for rendering of the media by a rating preference of the user.

16. The system of claim 11, wherein the media player includes atleast any one of a movie player, a DVD player with or without display, a set-top box, a DVR player, an on-line internet media streaming apparatus, a personal computer, a game rendering system, radio, cell phone, voicemail, television, MPEG player, web browser, virtually any other type of media player that supports video content rendering or any combination thereof, the set-top box is capable of rendering content in atleast one of on-demand, pay-per-view, through DVR or any combination thereof.

17. The game rendering system according to claim 16 include atleast one of a game console, a personal computer, an on-line internet gaming apparatus, any other media player capable of supporting video game rendering system or any combination thereof.

18. The system of claim 11 is capable of rendering atleast a category when the system receives a user request to display the rationale for a given rating of the mixed rated media, wherein the category includes atleast one of a mature language, violence, adult situation, nudity or any combination thereof.

19. The system of claim 11 is capable of providing means for rendering the content for the user to view those content category media to decide if that is acceptable for their content rendering.

20. The system of claim 11, wherein the system provides to the user with more informed preference on how mixed content is to be rendered.
